(19) United States
(12) Patent Application Publication
(10) Pub. No.: US 2007/0094675 A1
(43) Pub. Date: Apr. 26, 2007

(54) Object mobility

(76) Inventor: Caspar Michael Ryan, Melbourne (AU)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/257,055

(22) Filed: Oct. 25, 2005

(51) Int. Cl. G06F 9/46

(52) U.S. Cl. 719/330

(57) ABSTRACT

The present application discloses generally software applications that may be implemented as multiple mobile application objects distributed amongst a network of interconnected devices, and in particular to methods and schemes for enabling object mobility. In one aspect there is disclosed, a method of processing an initial software application to form at least two mobile application objects configured to cooperate with each other to provide one or more functions of the initial software application. The method includes, generating at least one local interface to enable the first application object to communicate with the second application object when the first application object and the second application object are running in a common execution environment; and generating at least one remote interface to enable the first application object to communicate with the second application object when the first application object and the second application object are running in different execution environments.

### FIELD OF THE INVENTION

The present invention relates generally to software applications that may be implemented as multiple mobile application objects distributed amongst a network of interconnected devices, and in particular to methods and schemes for enabling object mobility.

### BACKGROUND OF THE INVENTION

Traditional web based systems, and many first generation mobile applications, are based on a thin-client approach, with a dedicated server servicing many clients. In most cases clients are ‘thin’ in that they serve only as a presentation layer for interpreting a user interface specification delivered in the form of a markup language such as XML, HTML or WAP. Any other client processing is usually limited to simple authentication or preliminary data manipulation provided by a scripting language such as JavaScript or VBScript.

However, rapid advances in hardware technology have given current desktop machines the processing power of servers only a few years old. Mobile devices such as Intel XScale based PDA's now have CPU's running at hundreds of megahertz with 64 MB or more of program memory. Mobile telephone technology is also rapidly advancing with current generation phones able to run application code using standardised platforms such as Java 2 Micro Edition (J2ME), Symbian OS, and Microsoft NET Compact Framework. A significant point of this standardisation is that all of these potential application clients, namely desktop PCs, PDAs and smartphones are capable of running object oriented application code in a virtual machine environment, and thus potentially participate as active clients in a mobile object system operating in a heterogenous ad-hoc mobile environment.

However in order to avoid application developers from having to develop a separate version or versions of their application that can be run in this type of distributed heterogeneous environment, it would be advantageous to have methods for implementing a mobility subsystem and object/proxy structure that appears transparent to existing applications and provides an external interface to a separate system controller.

### SUMMARY OF THE INVENTION

In a first aspect the present invention provides a method of processing an initial software application to form at least two mobile application objects configured to cooperate with each other to provide one or more functions of the initial software application, the method including: generating at least a first application object and a second application object; generating at least one local interface to enable the first application object to communicate with the second application object when the first application object and the second application object are running in a common execution environment; generating at least one remote interface to enable the first application object to communicate with the second application object when the first application object and the second application object are running in different execution environments.

The method can further include, providing the first application object with a reference to either or both of a local or remote interface of the second application object.

The method can also further include, providing at least one interface to at least one of the application objects such that an external application program which would communicate with objects of the initial software application prior to processing, can communicate with the mobile application objects without modification to the external application program.

Preferably the method further includes generating a proxy which resides in the same execution environment as the first application object and which represents the second application object, said proxy including references to at least one of the local or remote application object interfaces for the second application object.

In the method, preferably at least one of, a first application object and a second application object, maintain at least one characteristic of the initial application.

In a second aspect the present invention provides a system including a plurality of processing devices configured to communicate with each other to run at least one application program, each processing device providing at least one execution environment which is able to run at least one software application object that forms part of the application program, wherein each software application object includes, at least one local reference for communicating with another predetermined application object when the software application object and its respective predetermined application object are running in the same execution environment, and at least one remote reference for communicating with the predetermined application object when the software application object and its predetermined application object are running in different execution environments, wherein said system is configured to pre-process the application program prior to its execution to generate at least two mobile software application objects to implement at least one function of the software application.

In a third aspect the present invention provides a software application formed from at least two mobile application objects configured to cooperate with each other to provide one or more functions of the software application, the application including: a first application object and at least one second application object: a first application object being linked to a second application object via a proxy including at least one local reference for communicating with a second application object via a local interface when the first application object and the second application object are running in a common execution environment, and a remote reference for communicating with the second application object via a remote interface when the first application object and a second application are running on different host devices.

The second application proxy is preferably dynamically updatable to update a reference to a location of the second application object. Preferably the proxy further includes a data field indicative of whether the first and second application objects are in the same execution environment. The data field indicative of whether the first and second application objects are in the same execution environment can be dynamically updatable.

In a fourth aspect the present invention provides a method of moving an application object from one execution environment to another, said application object being part of a software application formed from a first application object and at least one second application object, wherein the first application object communicates with a second application object via a proxy, said proxy including, at least one local reference for communicating with the second application object via a local interface when the second application object and the first application object are running in a common execution environment, and a remote reference for communicating with the second application object via a remote interface when the first application object and the second application are running in different execution environments; said method including: moving one or both of the application objects to a different execution environment; and updating a reference location relating to the second application object in at least the remote reference of the second application proxy.

The method can further include updating a reference location relating to the second application object in the local reference of the second application proxy.

The method can further include setting a variable, indicative of whether the first and second application objects are in the same execution environment, to a first value in the event that after moving one or both of the application objects the first and second application objects are in the same execution environment, and to a second value in the event that after moving one or both of the application objects the first and second application objects are in a different execution environment.

### BRIEF DESCRIPTION OF THE DRAWINGS

Illustrative embodiments of the present invention will now be described, by way of non-limiting example only with reference to the accompanying drawings. In the drawings:

FIG. 1 is a schematic diagram illustrating the various functional components of a system for executing distributed mobile applications;

FIG. 2 depicts the class structure of the system model used in an embodiment of the present invention;

FIG. 3 depicts the mobile object structure classes generated in an embodiment of the present invention;

FIG. 4 is a source code excerpt from an embodiment of the present invention illustrating the pre-processing of an object Domain and the three generated interfaces Domain, DomainLocal and DomainRemote;

FIG. 5 is a source code excerpt from an embodiment of the present invention illustrating the generated class named DomainProxy;

FIG. 6 is a source code excerpt from an embodiment of the present invention illustrating the generated class Domainimpl;

FIG. 7 is a flowchart depicting a process for method invocation between two co-located mobile objects in an embodiment of the present invention;

FIG. 8 is a flowchart depicting a process for method invocation between two mobile objects when they are not initially co-located on the same device;

FIG. 9 illustrates an exemplary situation illustrating the interaction between two objects;

FIG. 10 illustrates the interaction between the two objects of FIG. 9 when one of them has been made to be mobile using an embodiment of the present invention and the mobile object has been moved to a remote device;

FIG. 11 illustrates the interaction between the two objects of FIG. 9 when one of them has been made to be mobile using an embodiment of the present invention and the mobile object remains on the same device as the other object; and

FIG. 12 illustrates the steps in an error handling strategy used in an embodiment of the present invention.

### DETAILED DESCRIPTION OF THE EMBODIMENTS

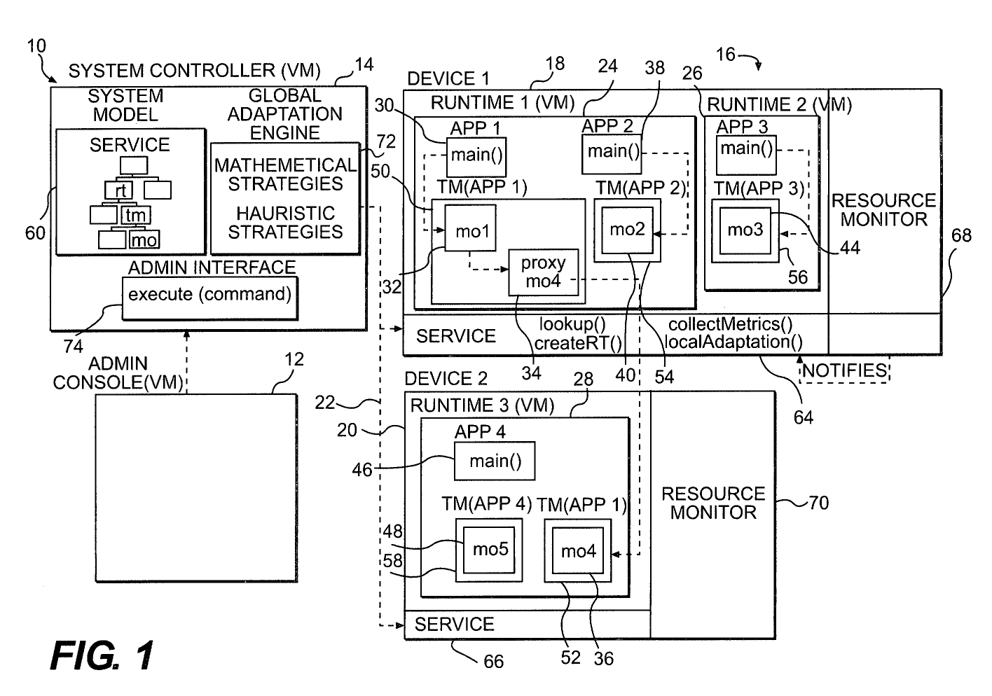

Referring now to FIG. 1 there is shown generally a system 10 for executing a distributed mobile application. The system 10 includes an administration console 12, a system controller 14 and a mobility sub-system 16. The mobility sub-system 16 includes, in this example, devices 18 and 20, although in other embodiments of the invention it will be understood that any number of devices may be provided. The devices 18 and 20 are connected together and to the system controller 14 by means of a generally wireless network link 22. The devices 18 and 20 may typically be embodied as Personal Digital Assistants (PDAs), laptop computers, smartphones or the like.

Each of the devices 18 and 20 run one or more execution environments for the execution of one or more software applications. In this figure, the device 18 includes execution environments 24 and 26, whilst the device 20 includes execution environment 28. The invention is suitable for implementation in object-oriented languages such as Java, and in such a case the execution environments 24, 26 and 28 may be runtimes in a Java virtual machine environment. Each execution environment facilitates the execution of one or more software applications. The execution environment 24 includes applications app 1 and app 2, the execution environment 26 includes application app 3 and execution environment 28 includes app 4. The application app 1 includes a main application element 30 linked to a first mobile object 32. A stub is inserted into the proxy 34 to link the mobile object 32 via proxy 34 to mobile object 36 forming part of the application app 1 but deployed at the separate device 20.

Application app 2 includes a main program element 38 linked to a mobile object 40, application app 3 includes a main application element 42 linked to a mobile object 44, and application app 4 includes a main application element 46 linked to a mobile object 48. In this example, the mobile objects 40, 44 and 48 are respectively deployed in the same execution environment, and on the same device, as their parent main application elements 38, 42 and 46.

Each execution environment includes one or more transport managers. A separate transport manager is provided for each cluster of mobile objects of an application to manage movement of those mobile objects between devices. Accordingly, transport managers 50 and 52 are provided for application app 1 since that application has mobile objects 32 and 36 distributed across both devices 18 and 20. However, applications app 2, app 3 and app 4 each include a single transport manager, respectively referenced 54, 56 and 58, since these applications include only one mobile object. The transport managers are responsible for managing the mobile objects with which they are associated, that is, objects that have been made to be mobile through the automatic generation of a proxy associated with that mobile object and the insertion of a stub into the proxy to link that mobile object to other mobile objects. The proxy/stub enables mobile objects to be migrated from device to device. The transport managers initiate the movement of mobile objects from device to device based upon instructions from the system controller 14 (or the local service) via the communications link 22, and provide services to proxies when the proxies must locate a mobile object that has been moved.

The system controller 14 maintains a system model 60 mapping the deployment of the various execution environments, applications, transport managers, mobile objects in the system 10 by encapsulating an abstract model that contains references to the various elements of the system. The system model 60 is built by communicating with services 64 and 66, respectively running on devices 18 and 20 providing information about execution environments and applications operating on that device. For example, the system controller 14 can initiate mobile object migration (or the swapping of a mobile object's implementation) in order to adapt to changing environmental conditions experienced by devices within the system 10. Resource monitors 68 and 70, respectively running on the devices 18 and 20, notify the system controller 60 via the services 64 and 66.

The system model 60 is created by capturing the key abstractions present in the system 10 as model entities. The mobility subsystem is made up of hierarchical containers of entities, starting at the coarsest grain with individual devices and progressing down to the finest-grain, being the mobile objects. The primary model entities form a hierarchical structure which provides a common interface for navigating up and down the hierarchy. This technique allows entities to inherit basic container operations such as the ability to add, remove and list children entities from a single parent class. Additionally traversal of the entire tree is simplified, as traversing classes can use a single means of navigation.

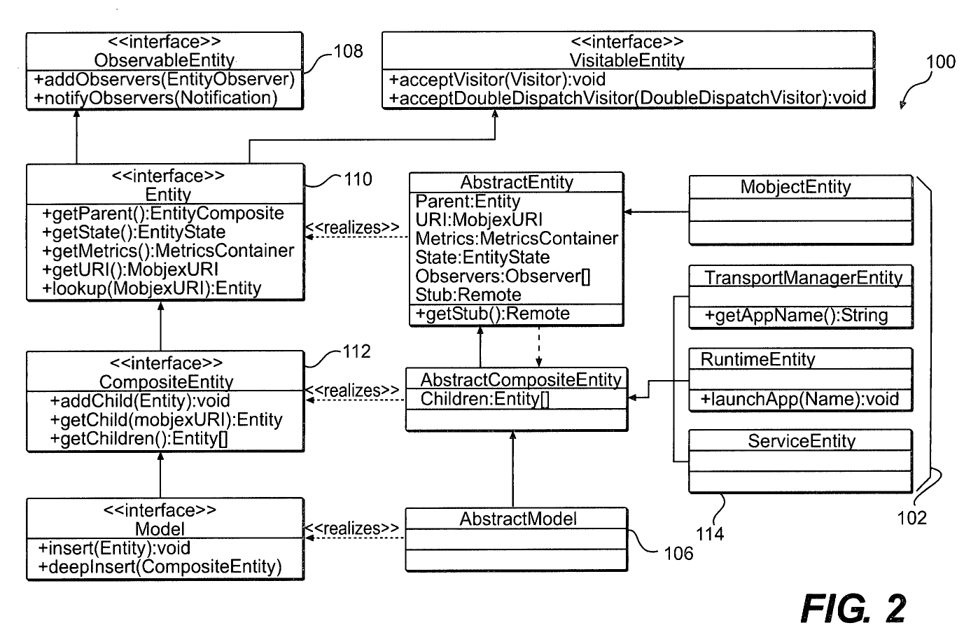

FIG. 2 details the architecture of the system model used in an embodiment of the present invention. The system model 100 provides a framework that represents the entities in the system 10 and the relationships between them. The term ‘Entity’ is used to mean any software component which can be identified in the system 10. Each entity has a parent container. Different types of entities occupy a different place in a hierarchy of entities. CompositeEntity 112 is a container for Entity objects 102. For example, the top-level container, AbstractModel 106, is a CompositeEntity 112, which contains Entities (ServicesEntities 114).

Instead of providing a single interface for entities that are containers as well as model entities, the responsibilities are split into two interfaces, Entity 110 and CompositeEntity 112. The Observable interface 108 is provided as a means for other objects to subscribe to an individual entity to receive updates on changes to the entity. This provides a mechanism for other elements of the system 10 such as the adaptation engine 72 to perform actions when the metrics of an object change. For example, the system model 100 itself can be subscribed to by this mechanism and it provides notices when an entity is created, destroyed or moved.

Dynamic operations on the model are defined using the so called ‘Command’ pattern. This pattern encapsulates a logical operation in an object, which can later be executed without an intimate knowledge of the internals of the command. This approach decouples the rest of the system from directly modifying the model.

Providing a dynamic model of a distributed application allows for certain concepts to be overlayed that would not be possible to implement at an operational level. One such example are the metrics associated with a specific entity. Each model entity has a reference to a metrics container, which characterises the entity's attributes. Details of an implementation of the metrics and an exemplary collection process are provided in our Australian provisional patent application number 2005905168, filed 19 Sep. 2005 in the name of the Australia Telecommunications Cooperative Research Centre, the contents of which are incorporated herein by reference. Another example is a scheme for uniquely identifying and locating objects, which is based on Universal Resource Identifiers (URIs).

The system controller 14 makes decisions automatically based upon adaptation strategies defined by a global adaptation engine 72, but also supports manual or ad-hoc manipulation from the administration console (GUI) 12 via a command-based interface 74 in the system controller 14. The system controller 14 enumerates the components of the system in a tree structure, allowing mobile objects to be moved between devices, as well as the substitution of mobile object execution environments. The automatic adaptation strategy is responsible for evaluating resource metrics for each device and software metrics for each application, using information provided by the services of the individual devices. Based upon the outcome of the evaluation, the system controller 14 may choose to initiate object movement (or implementation substitution) in order to adapt to the new conditions.

Adaptation is generally achieved via object mobility, in which individual mobile objects and other application components can migrate through the system 10 whilst maintaining location transparency via remote object references. A decision as to when and how object migration should be performed is dependant upon factors such as availability of device resources and nature of interactions occurring between mobile objects. Software code metrics which characterise objects and their interactions, and metrics of resources such as network, CPU and memory, are collected in the system in order to estimate the impact on quality attributes such as efficiency and reliability of mobile objects. An example of how adaptation is achieved is provided in our Australian provisional patent application number 2005905168.

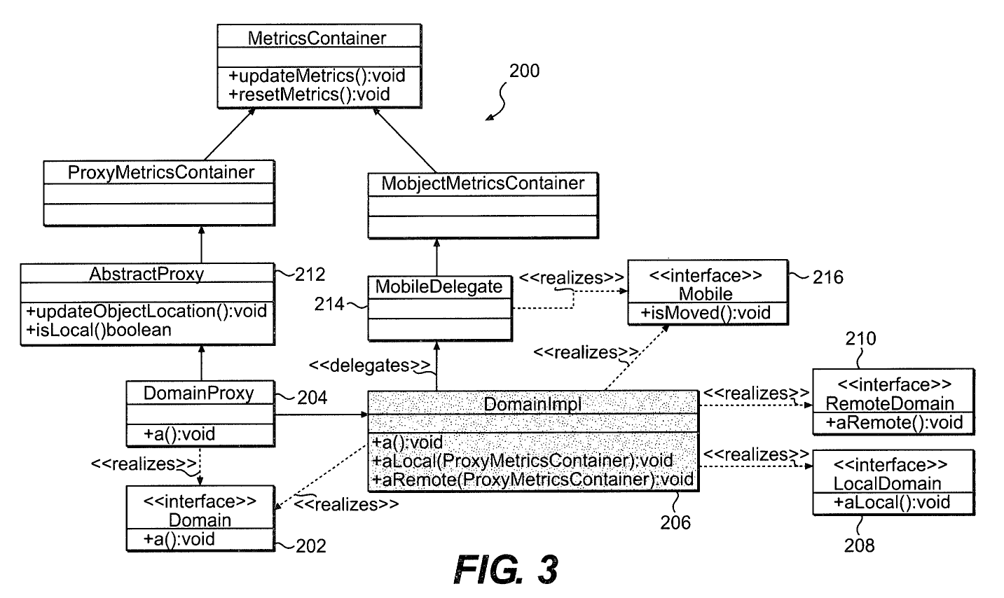

In the illustrative embodiments, although the transport manager will initiate moves based on instructions from the system controller and provide support for forwarding services, garbage collection and memory management, much of the object distribution functionality of the mobility sub-system is precompiled into the application using a compiler referred to herein as mobjexc. Mobjexc is based on XML transformation of the original source code to produce modified source code based on the class diagram 200 shown in FIG. 3. Where source code is not available, reflection on the original class is used to extract the information required by the transformation, which can be done in one particular embodiment using the Java reflection APIs. In this case, one extra level of local method call indirection is required since the generated code must perform an invocation on the original class. The generated source code is then compiled into final executable using standard compilers, e.g. Java or rmic in one particular embodiment after which it is usually deleted but may be kept for debugging purposes using a command line switch.

Referring to FIG. 3, in the illustrative embodiment, transparency at the source code level in order to maintain all original object oriented relationships including polymorphism and inheritance can be achieved by generating a Domain interface 202, which matches the name and public method signatures of the original class. The Domain interface 202 is implemented (realized in UML terms) by the DomainProxy 204, which is in turn referenced by the original code in place of the original Domain class. The proxy 204 in turn has a reference to the newly generated Domainimpl class 206 that provides both a local 208 and remote 210 implementation of the original Domain methods, which are substituted intact from the original Domain class. This allows methods to be called directly via local reference call-through when the caller is in the same address space as the callee, or remotely via a stub when this is not the case.

The implementation of the generated remote interface 210 performs additional marshalling beyond that of a standard remote method invocation, in order to copy and uncopy parameters so as to simulate the parameter by reference semantics of local calls. This marshalling, which is done by reflective deep copy, is provided to ensure that application semantics do not change when deploying existing applications as mobile objects. i.e. existing applications may assume that non primitive objects would be handled by reference and thus the mobility sub-system simulates this via additional marshalling. This embodiment has the added benefit of being more efficient for small mutable objects, where it would be impractical to call an operation via remote reference. If parameter marshalling is not required in a particular embodiment, the deployer can disable it on a per class basis via. configuration settings and use mobile objects as remote parameters, to ensure true pass by reference semantics where appropriate.

A further level of source code transparency is provided by maintaining class hierarchies and allowing the mobility of objects which already extend domain specific or system classes. This is achieved by having a parallel hierarchy of proxies for each of the classes in the original hierarchy with the ‘superproxy’ class (the proxy at the top of the proxy hierarchy) extending AbstractProxy 212 in order to gain the functionality required to transparently resolve local and remote references. Rather than extending a superclass, the object mobility code in the object implementation (Domainlmpl 206) is derived from a delegate class called MobileDelegate 214 that implements the Mobile interface 216. The Domainlmpl 206 itself also implements Mobile 216 but simply calls-through to the functionality provided by the delegate 214.

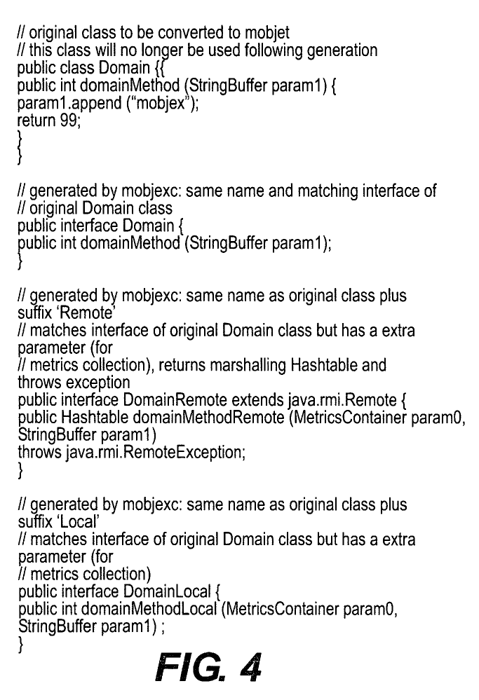

FIG. 4 shows one embodiment of the effect of pre-processing a simple Java class (Domain) that has one method (domainMethod( )), with mobjexc. This code segment will be used in describing an implementation of a migration strategy used by a mobility sub-system in an embodiment of the invention. The original class Domain is processed to generate three new interfaces Domain, DomainLocal and DomainRemote. Note that once the generation has been done, the original Domain class is no longer used. Client code instead refers to an implementation of the newly generated Domain interface. The principle benefit of using the original name is that code referring to the original Domain class need not be modified to refer to the new mobile enabled object since the mobility code is insulated by the proxy class.

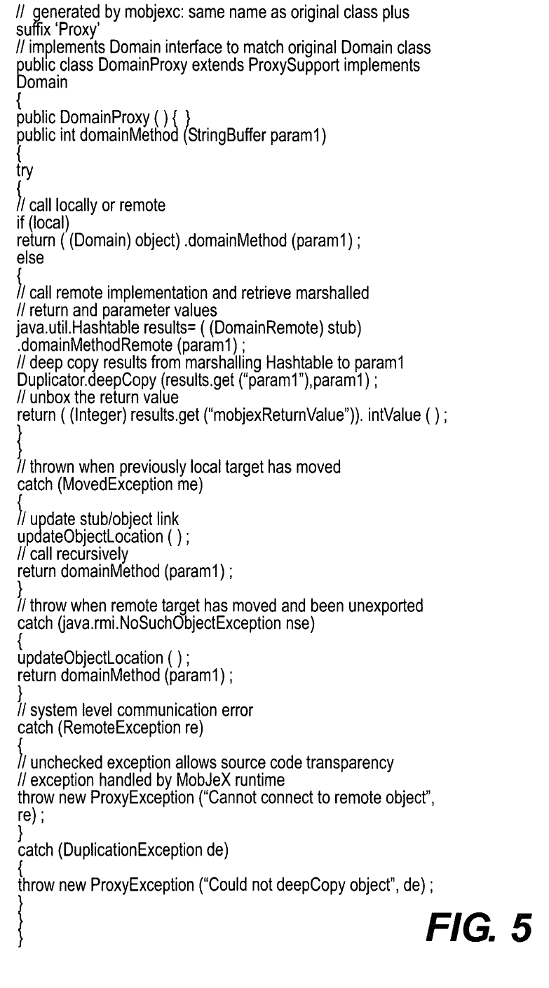

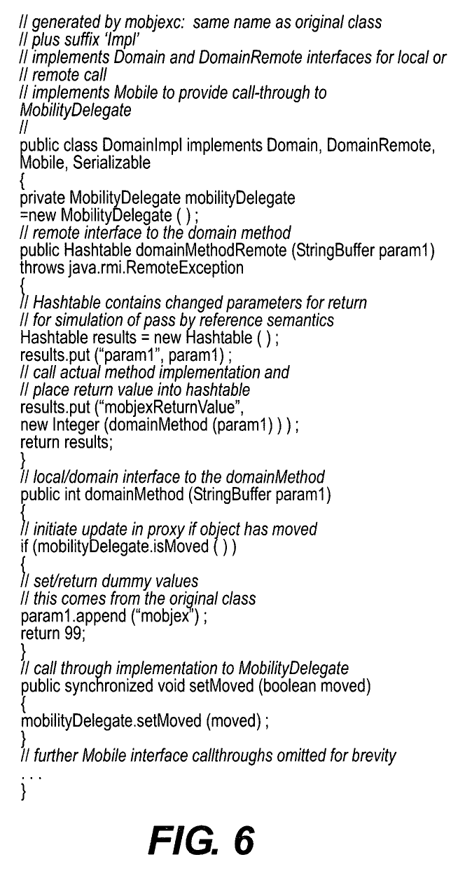

FIG. 5 shows the generated proxy class named DomainProxy. The proxy serves two main purposes. Firstly, it maintains either a local or remote reference to the target object (DomainImpl) which is illustrated in FIG. 5. Secondly, whenever the source or target object of this reference moves, the proxy is responsible for updating the reference as described below.

In embodiments of the invention, migration of objects is a co-operative effort which happens over time between a proxy, the mobile object and its respective transport manager. In general terms migration occurs as follows:
1. A migration command is issued (eg. by the system controller) for any mobile object (as identified by uri's) between any two execution environments on any two devices.
2. The object is serialized and transported to the destination transport manager.
3. Classes are requested from the source transport manager via remote classloading if not already available.
4. References to the moved object are updated upon the next call, via collaboration between proxies, transport managers and mobile objects.

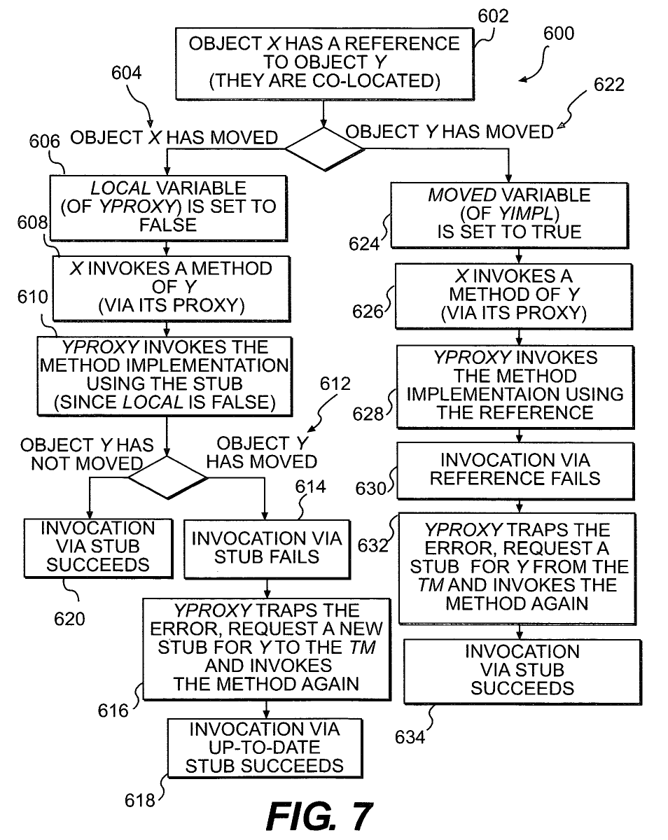

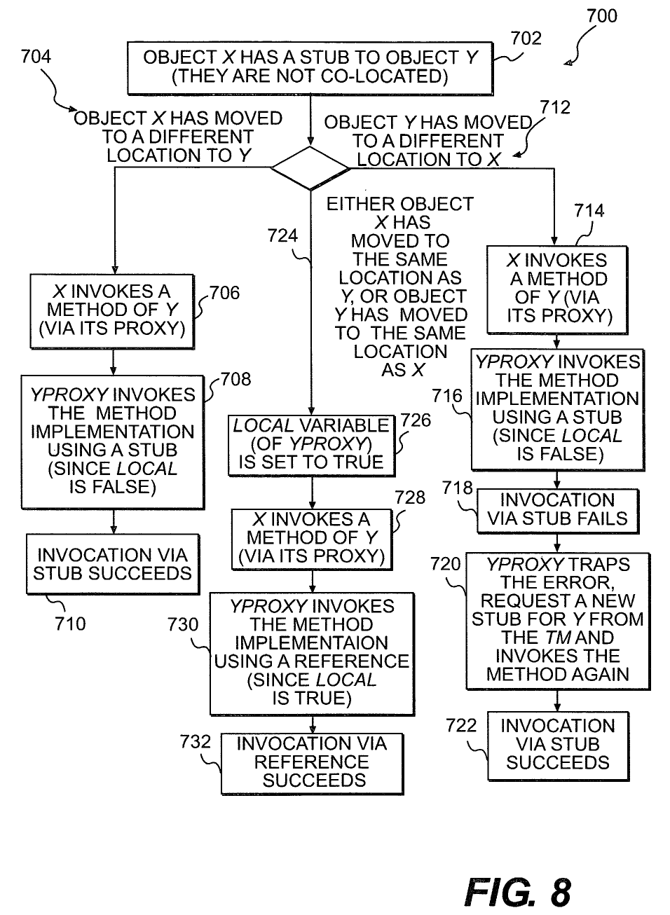

Whenever the source or target object moves, the proxy can update the reference according to the following possibilities:
1. Object X has a reference to a Domainimpl object (Y) via a DomainProxy. X and Domainimpl are co-located, therefore the proxy refers directly to the Domainlmpl via a local reference. FIG. 7 depicts this procedure.
2. Object X has a reference to a Domainimpl object (Y) via a DomainProxy. X and the Domainimpl are NOT co-located and thus the proxy refers to the Domainimpl remotely via the stub. This process is described in FIG. 8.

In FIG. 7 objects X and Y are initially co-located the same host. Accordingly, as indicated at 602 the proxy of object X has a local reference to object Y.

In the event that object X has moved, as indicated at 604, the local variable of Y's proxy is set to False at 606 as object Y is no longer local with respect to X. Next in 608, object X invokes a method of object Y via Y's proxy, which in step 610 invokes the method implementation using a stub since object X and Y are no longer on the same host. In the event that object Y has also moved as indicated at 612 the invocation of the method of object Y fails as indicated at 614. Next in step 616, Y's proxy traps the error and requests a new stub for object Y from the transport manager. It then attempts to invoke the method again using the updated stub in step 616. This should result as indicated at 618 invocation of the method of object Y.

In the event that object Y has not moved, the stub used in step 610 will point to the correct location of object Y and invocation of the method by the stub will succeed as indicated at 620.

In the event that object Y has moved, as indicated at 622, the moved variable of Ylmpl is set to True to show that the move has occurred as shown in step 624. Next in 626, object X invokes the method of object Y via its proxy and then in 628 Y proxy invokes method implementation using the local reference. However, because object Y has moved, invocation of the method in step 628 fails as indicated in 630. In step 632 Y proxy traps the error and requests a stub (rather than a local reference) for object Y from the transport manager and again invokes the method. This time invocation should succeed as indicated at 634 because the correct stub is used by Y proxy in the invocation of the method.

Turning now to FIG. 8 which depicts a flow chart 700 illustrating the situation in which object X and object Y are not located on the same host. In this case, object X has a stub pointing to object Y as shown at 702. In the event that object X has moved to a different location of to object Y as indicated at 704, object X will invoke a method of object Y via its proxy in step 706. Y proxy then invokes the method implementation using a stub. Because X and Y are not on the same host the variable local is set to False as indicated in step 708. As indicated at 710 implication by the stub succeeds.

Next as indicated 712, object Y has moved to a different location to object X. In this case, object X invokes a method of Y via its proxy at step 714. Next in 716, Y proxy invokes the method implementation of object Y using a stub since once again the variable local is set to false. As indicated at 718, invocation of the method via the stub fails because of object Y has moved in 720. Y proxy traps the error and requests a new stub for Y from the transport manager and once again invokes the method. Since the stub is now up-to-date, invocation via the stub succeeds as indicated at 722.

In a third option either object Y has moved to the same location as object X or vice versa as indicated by branch 724 of the flow chart 700. In this case, the local variable of Y proxy is set to true because objects X and Y are now located on the same device as shown in step 726. Next in 728, object X invokes a method of object Y via its proxy and in step 730 X proxy invokes the method implementation using a local reference. Invocation via the reference succeeds as indicated at 732, because the objects X and Y are located on the same host.

Consider for example, the case of a Taxi Dispatching System (TDS) which is intended to help an operator efficiently dispatch a fleet of taxis in response to calls from corporate customers. One of the main functions of the exemplary system is to maintain a list of customer accounts and to manage the ad-hoc and periodic generation of invoices.

The exemplary TDS is based on five main object classes:
location manager [Im];
client manager [cm];
job manager [im];
taxi manager [tm]; and
user interface [ui].

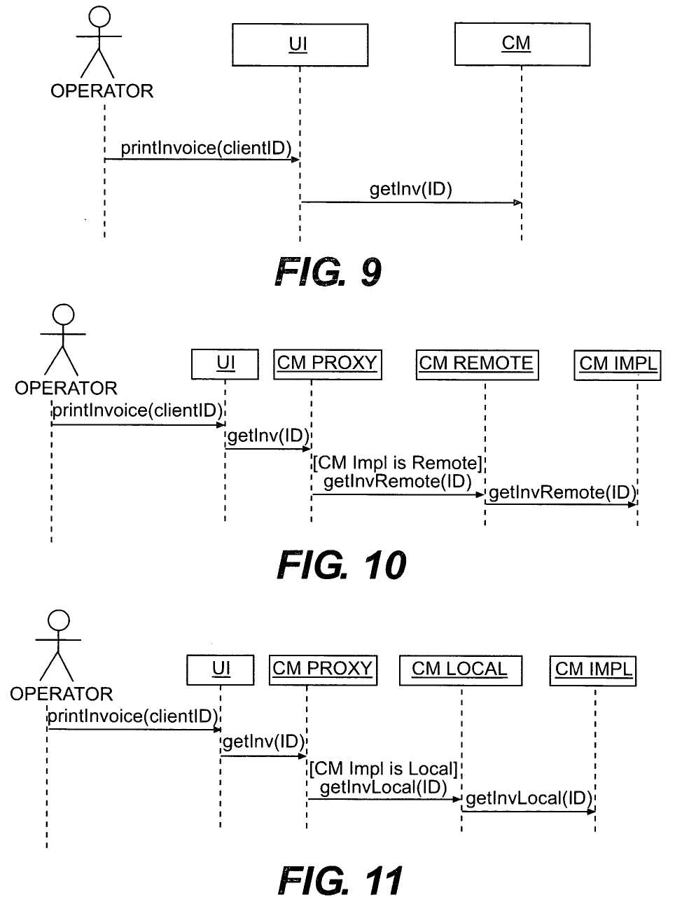

To view the invoices for a set of customers, the system operator interacts with the system interface [ui]. To satisfy the operator request the object [ui] send a message (e.g. with the customer id) to the object [cm] which returns the invoice details. Object [ui] can display the invoice details on the screen or print the invoice. A diagram representing the interaction among the objects [ui] and [cm] in the original system is presented in FIG. 9.

When [cm] is transformed into a mobile object, the scenario depicted in FIG. 9 can be mapped to two different scenarios which are depicted in FIGS. 10 and 11. Which of these scenarios occurs when the operator requests an invoice depends on whether object [cm] has migrated to a remote device (as depicted in FIG. 10) or it is located in the same device as object [ui] (as in FIG. 11).

Turning firstly to FIG. 10 which depicts a situation in which the [cm] object has migrated to a host remote to that of the user interface object [ui]. In this case, when the operator 900 uses object [ui] 902 to request an invoice for the customer, the user interface invokes a method of the client management object using the stub 908 embedded in its proxy 904 because the client management implementation 906 resides on a different host to the user interface object 902 (i.e. the local variable of [cm] proxy is set to false). Altematively in FIG. 11 the operator 900 interacts with object [ui] 902 to request an invoice from the client management object. In this case, client management proxy 904 has the local variable set to true as the client management implementation 906 is hosted on the same device. In this case the client management proxy 904 uses a local interface 1000 to obtain the requested data from the client management implementation 906.

The proxy model discussed above enables error handling to be carried out. As the DomainProxy (204 in FIG. 3) does not expose a remote interface, exceptions required for the remote method invocation can be caught internally within the proxy. The ability to reference objects locally removes the need for error handling code in the generated code. Exceptions thrown during migration are also handled close to the cause by the Transport Manager or execution environment.

Error handing in the system described in this document has been implemented as a so called “chain of responsibility”, whereby errors are sent along a chain of ‘error handlers’, giving each handler an opportunity to rectify the error. Each component of the system (as described previously) may act as an error handler and as such is given an opportunity to handle the error. Ultimately if all other error handlers are unable to correct the error the error goes to the user. The manner in which an error is handled will change depending on various factors, such as the nature of the error and object, the duration over which the error persists or occurs etc.

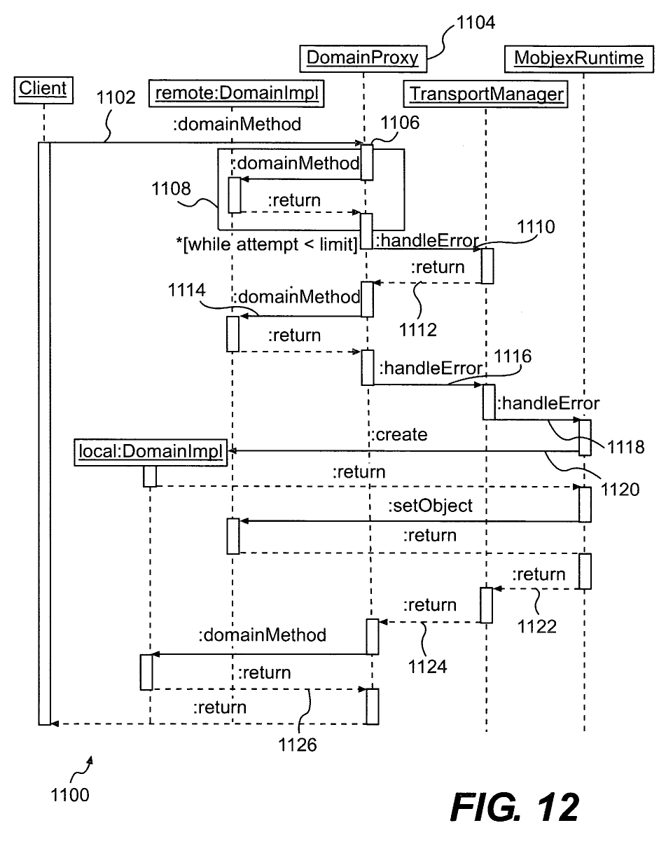

FIG. 12 illustrates a sequence 1100 for handling communication errors for a replaceable object. Initially in 1102 an attempt is made to invoke a method of the object Domain. The DomainProxy 1104 attempts to call the method and fails 1106. Initially, the simplest strategy for handling this type of failure is simply for the DomainProxy 1104 to try again as indicated by loop 1108. DomainProxy is configured to maintain a count of failed access attempts and continue to call the method until such time as a predetermined threshold is met. A complementary approach to this is to delay further attempts to call the method for a random period of time and then attempt the communication again.

If the object cannot be reached after repeated attempts, (which would indicate a permanent network failure), the transport manager is required to attempt to rectify the situation as indicated at 1110. Typically the transport manger will update the internal references of the proxy (1112) to point to the correct network address of the remote implementation of Domain, and DomainProxy will retry the call again 1114. If this fails the error is again passed to the transport manager 1116 for handling. If a remote object can't be contacted after a period of time, the system will take steps to establish communication with a replacement object, so the client application can proceed. Typically the replacement object that most closely resembles the original object will cause the least impact on the running of the application. Using check-pointing and rollback mechanisms, it may be possible to get a copy of the original object, (typically in an earlier state). However given the overhead associated with object check-pointing and rollback mechanisms in certain circumstances it will be cheaper to simply create a new object. This approach is advisable if the class is immutable or has no instance variables of importance, as any data contained within the object will be lost.

As the transport manager is able to directly manipulate the proxy and its internal references the mechanisms for object replacement can advantageously be implemented in the transport manager. If the transport manager is unable to create a replacement object responsibility for correcting the error then falls to the execution environment.

If the TM cannot find a replacement the error is passed to the execution environment in step 1118. The execution environment can contact other known transport managers of the application to satisfy this responsibility. If none of the known transport managers can provide a new copylinstance of the object, the responsibility passes to the Service.

Once the new instance of the object is created at step 1120 this is reported to the transport manager 1112 which in turn updates the reference in DomainProxy 1124 and the method can then be invoked as necessary 1126.

Altematively, if the execution environment was unable to replace the object, the service will contact the rest of transport managers, via the System Controller (which can provide a full list of transport managers for any given application), to fulfil this responsibility.

Again, if the service is unable to recover the error, responsibility falls on the System Controller. Repeated failure to contact a remote object is indicative of a prolonged node or network failure. Every such failure is preferably reported to the System Controller, which can then deem a given remote Service unreachable. If a remote Service is declared unreachable then objects are relocated from that device to an alternate device wherever possible. If the previous strategies fail or are unavailable for a given object, then the responsibility falls upon the System Controller to correct the error. As the System Controller has a model of each of the Services it can make decisions to move a whole group of objects such as a complete Transport Manager or execution environment to a new location. In effect this would enable the isolation of poorly connected nodes, as no mobile objects would reside on them. In the situation where a large network splits into multiple smaller networks, application objects can be re-arranged to better reflect the network topology. Strategies for application adaptation to the environment are discussed in separate applications discussed above.

As will be appreciated by those skilled in the art securing ad-hoc networks of the type discussed herein is often a concern. The primary point of vulnerability in such a system lies in its communication lines. Components of the network communicate with other components by sending executable commands, so the possibility exists for an attacker to simply register a rogue component and execute commands that would compromise the system or capture sensitive information. To prevent this, the system architecture of a preferred embodiment allows different techniques (in terms of security and associated overhead) to be used in the system to prevent messages being intercepted, played back out of sequence, and also to confirm the identity of a sender of a communication.

In one embodiment, techniques such as public key cryptography are used. Distributed components of the system exchange public keys as part of their initial publisher/subscriber process and then (some or all) messages are signed and encrypted before being sent. Message authentication digests can also be included with the commands such that out of sequence commands inserted as part of a replay attack could be detected.

In the same way, different levels of security can be employed in the proxies to secure information exchanged by the distributed objects of an application. For example, in one embodiment after the parameters of a remote method invocation are serialised and before they are sent, they are encrypted and signed.

It will be understood that the invention disclosed and defined in this specification extends to all alternative combinations of two or more of the individual features mentioned or evident from the text or drawings. All of these different combinations constitute various alternative aspects of the invention.

1. A method of processing an initial software application to form at least two application objects configured to cooperate with each other to provide one or more functions of the initial software application, the method including:
generating at least a first application object and a second application object;
generating at least one local interface to enable the first application object to communicate with the second application object when the first application object and the second application object are running in a common execution environment;
generating at least one remote interface to enable the first application object to communicate with the second application object when the first application object and the second application object are running in different execution environments.

2. The method of claim 1, which further includes, providing the first application object with a reference to either or both of a local or remote interface of the second application object

3. The method of claim 2, which further includes, providing an interface to at least one of the application objects such that an external application program which would communicate with an object of the initial software application prior to processing, can communicate with the generated application objects without modification to the external application program.

4. The method of claim 3, wherein the interface of the first application object replicates an interface of the initial software application.

5. The method of claim 1 which further includes generating a proxy which resides in the same execution environment as the first application object and which represents the second application object, said proxy including references to at least one of the local or remote application object interfaces for the second application object.

6. The method of claim 1, wherein said method is performed prior to running the initial software application in a network.

7. The method of claim 1 wherein, at least one of, a first application object and a second application object, maintain at least one characteristic of the initial application.

8. The method of claim 7 wherein relationships between objects or classes in the initial application are replicated or maintained in the generated first and second application objects.

9. The method of claim 8 wherein an inheritance of at least one object or class forming part of the initial application is replicated or maintained in the first or second application objects.

10. The method of claim 8 wherein polymorphism of a method of at least one class forming part of the initial application is replicated or maintained in the first or second application objects.

11. The method of claim 8 wherein the location of an application object is specified using a universal resource identifier.

12. A system including a plurality of processing devices configured to communicate with each other to run at least one application program, each processing device providing at least one execution environment which is able to run at least one software application object that forms part of the application program, wherein each software application object includes, at least one local reference for communicating with another predetermined application object when the software application object and its respective predetermined application object are running in the same execution environment, and at least one remote reference for communicating with the predetermined application object when the software application object and its predetermined application object are running in different execution environments, wherein said system is configured to pre-process the application program prior to its execution to generate at least two software application objects to implement at least one function of the software application.

13. The system of claim 12 which further includes a system controller that is configured to maintain a system model representing a plurality of entities present in the system.

14. A software application formed from at least two mobile application objects configured to cooperate with each other to provide one or more functions of the software application, the application including:
a first application object and at least one second application object:
a first application object being linked to a second application object via a proxy including at least one local reference for communicating with a second application object via a local interface when the first application object and the second application object are running on in a common execution environment, and a remote reference for communicating with the second application object via a remote interface when the first application object and a second application are running on different host devices.

15. The software application of claim 14 wherein the second application proxy is dynamically updatable to update a reference to a location of the second application object.

16. The software application of claim 15 wherein the proxy further includes a data field indicative of whether the first and second application objects are in the same execution environment.

17. The software application of claim 16 wherein a data field indicative of whether the first and second application objects are in the same execution environment is dynamically updatable.

18. The software application of claim 14, wherein said software application objects were generated from an original application and wherein at least one of, the first application object and the second application object, maintain at least one characteristic of the original application.

19. The software application of claim 18 wherein relationships between objects or classes in the original application are replicated or maintained in the first and second application objects.

20. The software application of claim 18 wherein an inheritance of at least one object or class forming part of the original application is replicated or maintained in the first or second application objects.

21. The software application of claim 18 wherein polymorphism of a method of at least one class forming part of the original application is replicated or maintained in the first or second application objects.

22. The software application of claim 19 wherein the location of least one the application objects is specified using a universal resource identifier.

23. A method of moving an application object from one execution environment to another, said application object being part of a software application formed from a first application object and at least one second application object, wherein the first application object communicates with a second application object via a proxy, said proxy including, at least one local reference for communicating with the second application object via a local interface when the second application object and the first application object are running in a common execution environment, and a remote reference for communicating with the second application object via a remote interface when the first application object and the second application are running in different execution environments; said method including
moving one or both of the application objects to a different execution environment; and
updating a reference location relating to the second application in at least the remote reference of the second application proxy.

24. The method of claim 23 wherein the method further includes updating a reference location relating to the second application object in the local reference of the second application proxy.

25. The method of claim 23 where the method further includes setting a variable, indicative of whether the first and second application objects are in the same execution environment, to a first value in the event that after moving one or both of the application objects the first and second application objects are in the same execution environment, and to a second value in the event that after moving one or both of the application objects the first and second application objects are in a different execution environment.

26. The method of claim 23 wherein the movement of an application object from one execution environment to another includes updating at least one universal resource identifier.

27. The method as claimed in claim 23 wherein, in the event that a reference location relating to the second application is found to be unavailable the method includes, retrying the reference location at least once.

28. The method as claimed in claim 23 wherein in the event that a reference location relating to the second application is found to be unavailable the method includes retrying the reference location after a substantially randomly selected time has elapsed.

29. The method as claimed in claim 23 wherein in the event that a reference location relating to the second application is found to be unavailable the method includes, updating a reference location relating to the second application object in at least the remote reference of the second application proxy.

30. The method as claimed in claim 23 wherein in the event that the updated reference location relating to the second application is found to be unavailable the method includes, attempting to identify a replacement application object for the second application object.

31. The method as claimed in claim 30 wherein in the event that a replacement application object is identified the method includes updating a reference location relating to the second application to a location of the replacement application object.

32. The method as claimed in claim 30 wherein in the event that a replacement application object is not identified the method includes creating a replacement application object.

33. The method as claimed in claim 32 wherein in the event that a replacement application object is created the method includes updating a reference location relating to the second application proxy to a location of the replacement application object.

34. The software application of claim 14 wherein at least some data communicated between the a first application object and a second application object or a proxy of the second application object are encrypted and/or signed prior to transmission.

35. The software application of claim 34 wherein cryptography keys are exchanged between the first application object and at least one second application object during application initialisation.

36. The software application of claim 14 wherein a message digest is transmitted with at least some data communicated between the first application object and a second application object or a proxy of the second application object.
